(19) United States
(12) Patent Application Publication
(10) Pub. No.: US 2007/0255791 A1
(43) Pub. Date: Nov. 1, 2007

(54) System and Method for Managing Threadsd in a Network Chat Environment

(75) Inventors: Maarten P. Bodlaender, Eindhoven (NL); Nico W. Schellingerhout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,099

(22) PCT Filed: Apr. 19, 2005
(86) PCT No.: PCT/IB05/51277

§ 371 Date: Oct. 19, 2006

Related U.S. Application Data
(60) Provisional application No. 60/564,002, filed on Apr. 21, 2004.

(51) Int. Cl. G06F 15/173

(52) U.S. Cl. 709/206

(57) ABSTRACT

A system and method is provided for managing conversation threads 520 in a chat room 505 operating in a network chat environment. A chat controller 120 provides an exchange of information in the form of a plurality of chat lines between a plurality of chat clients registered with a chat room 505. A thread management controller 130 determines one or more associations between the chat lines and identifies one or more threads 520 corresponding to the associations. The thread management controller 130 further assigns each of the chat lines to one of the threads 520.

The present invention is directed, in general, to network chat environment and, more specifically, to a system and method for managing conversation threads in a chat room.

Communications networks, such as the Internet or World Wide Web (“Web”), have enabled people throughout the world to exchange information and ideas in real-time. One of the most popular information exchanging forums is called a “chat room.” Chat rooms are provided to members (chat clients) of an on-line service provider to allow multiple chat clients to simultaneously engage in real time text conversations with each other. A chat room is administered by a chat server that receives messages from chat clients and distributes the messages to the chat clients registered with the chat room.

Chat rooms are normally related to a specific topic. Chat clients register with the chat rooms that advertise topics of interest. For example, the topic of discussion in one chat room may be related to the latest news headline, while the topic of discussion in another chat room may be related to a popular television program.

Although the conversations in a chat room typically center around the chat room topic, oftentimes chat room clients engage in conversations that are off-topic. Many on-line service providers utilize monitors in the form of human employees or monitoring software to ensure that the conversation remains applicable to the selected chat room topic. For example, if a chat client wishes to converse with another chat client concerning a topic different than the chat room topic, the monitor can suggest that the chat clients enter a “private” chat room to continue their conversation. More commonly, one or more of the chat clients in a chat room decide to create a new chat room and invite other chat clients to join their new chat room.

However, creating a new chat room and asking participants to join the newly created chat room is a manual and time-consuming process, which is an inconvenience to many chat clients. In addition, receiving messages from a chat room monitor can be aggravating to some chat clients, and can possibly be a deterrent to future use of chat rooms by those chat clients.

Another problem that many chat clients complain of is difficulty in following the chat room conversation. Within a chat room, the maintained history is a sequence of chat lines. In many cases, it is difficult to ascertain the context of a particular chat line. For example, if there are many chat clients posting chat lines simultaneously, it can be difficult to determine who is reacting to whom.

There is therefore a need in the art for a system and method that is capable of managing conversation threads in a chat room. There is also a need in the art for a system and method to filter off-topic threads and move a thread and it's participants to another chat room. In addition, there is a need in the art for a system and method to allow chat clients to follow the conversation in a chat room.

To address the deficiencies of the prior art mentioned above, the system and method of the present invention is capable of managing conversation threads in a chat room. The system and method of the present invention is also capable of filtering off-topic threads and creating new chat rooms for off-topic threads and their participants. The system and method of the present invention is further capable of providing a mechanism for chat clients to follow the chat room conversation.

The system and method of the present invention comprises a chat controller and a thread management controller in a network chat environment. The chat controller provides an exchange of information in the form of a plurality of chat lines between a plurality of chat clients registered with a chat room. The thread management controller determines one or more associations between the chat lines and identifies one or more threads corresponding to the associations. The thread management controller further assigns each of the chat lines to one of the threads.

In one advantageous embodiment of the invention, the thread management controller is further capable of associating each of the chat clients with one of the threads and provides to each of the chat clients those chat lines assigned to the associated thread.

In a further embodiment of the invention, the thread management controller is capable of providing chat line references usable by the chat clients to refer to the chat lines.

It is an object of the present invention to provide a system and method for managing threads in a chat room.

It is another object of the present invention to provide a system and method for filtering off-topic threads from a chat room.

It is also an object of the present invention to provide a system and method for enabling chat clients to refer to previous chat lines to improve understandability of chat line conversation.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

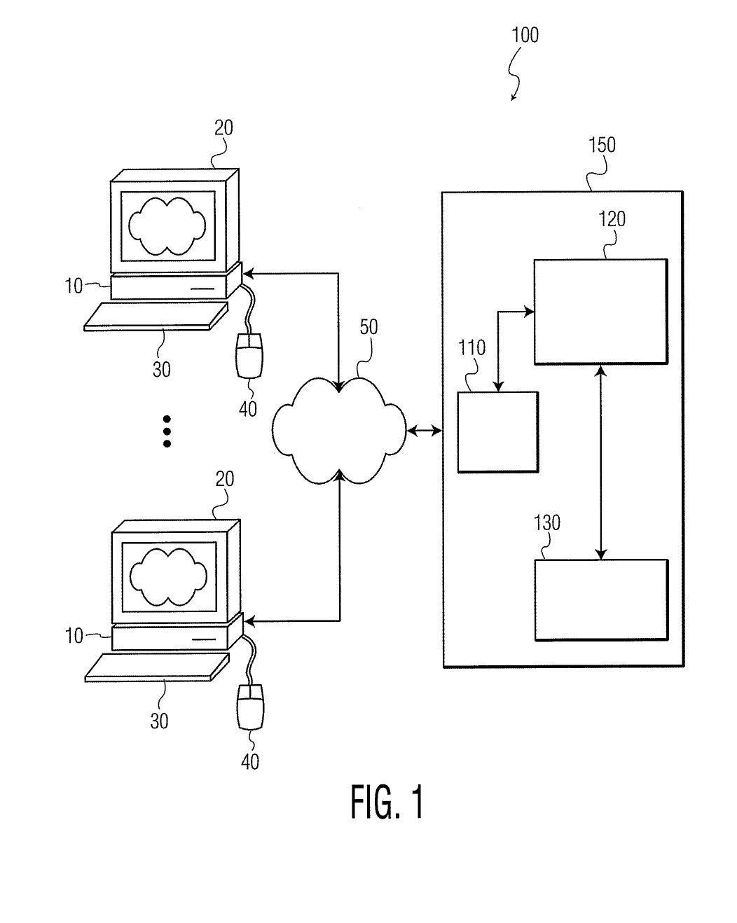

FIG. 1 is a schematic overview of an exemplary system for managing threads in a chat room in accordance with the principles of the present invention;

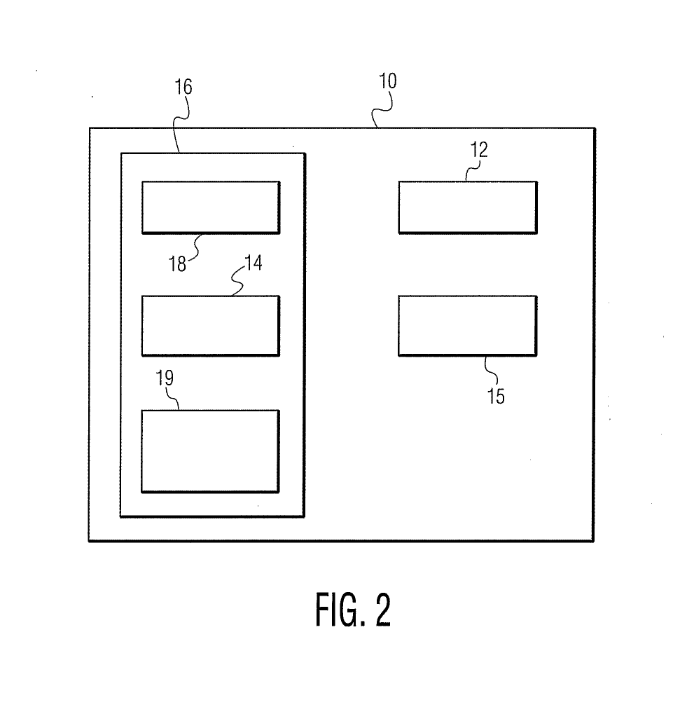

FIG. 2 is a block diagram of an exemplary computer comprising thread management capabilities in accordance with the principles of the present invention;

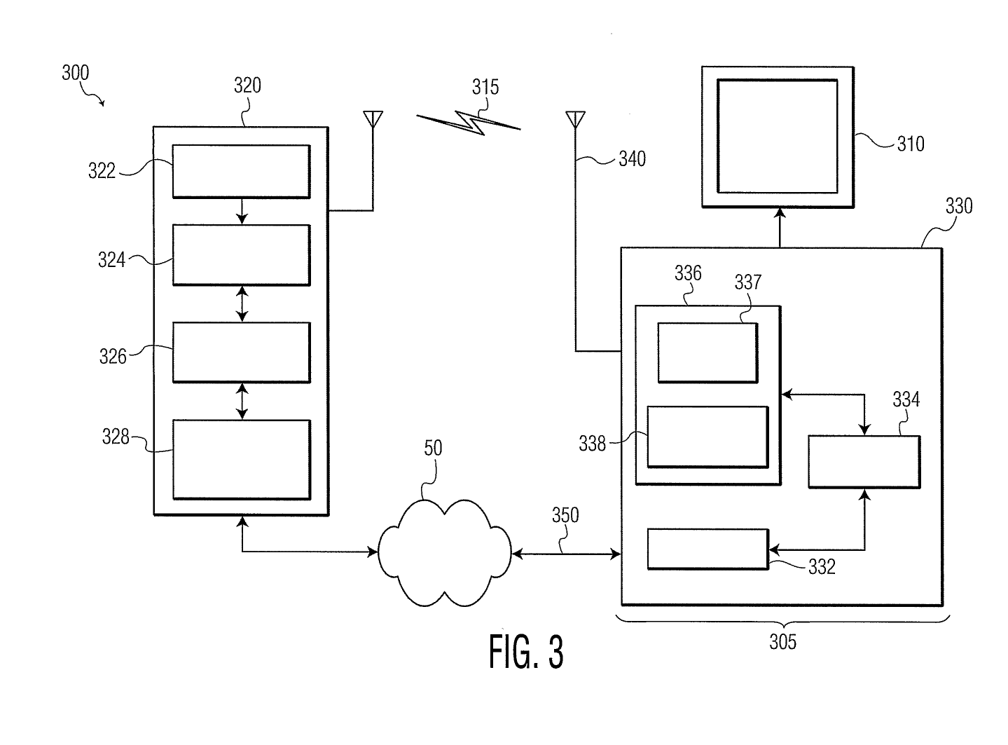

FIG. 3 block diagram of an exemplary interactive television system comprising thread management capabilities in accordance with the principles of the present invention;

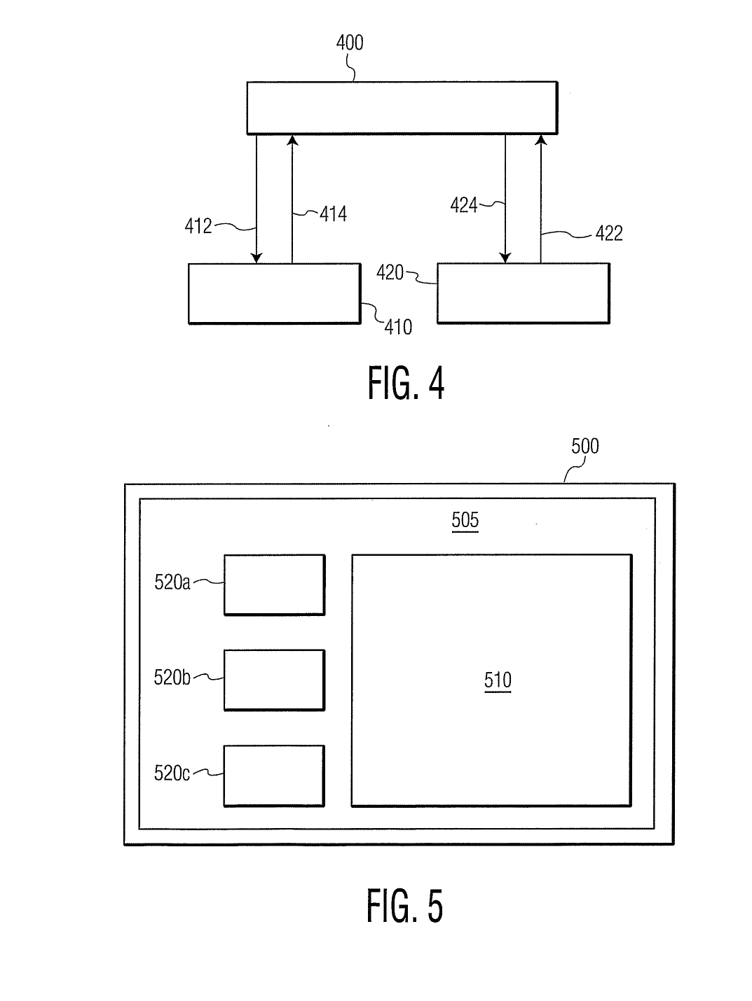

FIG. 4 is a logical flow diagram illustrating chat line filtering in accordance with an advantageous embodiment of the present invention;

FIG. 5 is a schematic view of a display device for displaying threads of a chat room in accordance with another advantageous embodiment of the present invention;

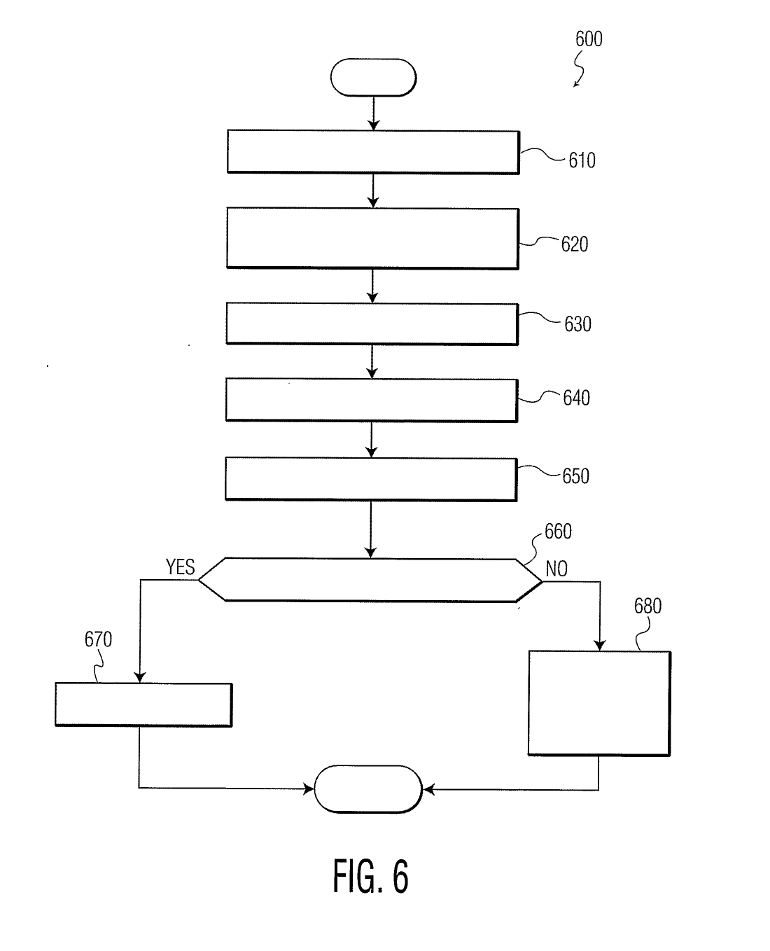

FIG. 6 illustrates a flow chart showing the steps for managing threads of a chat room in accordance with the principles of the present invention; and

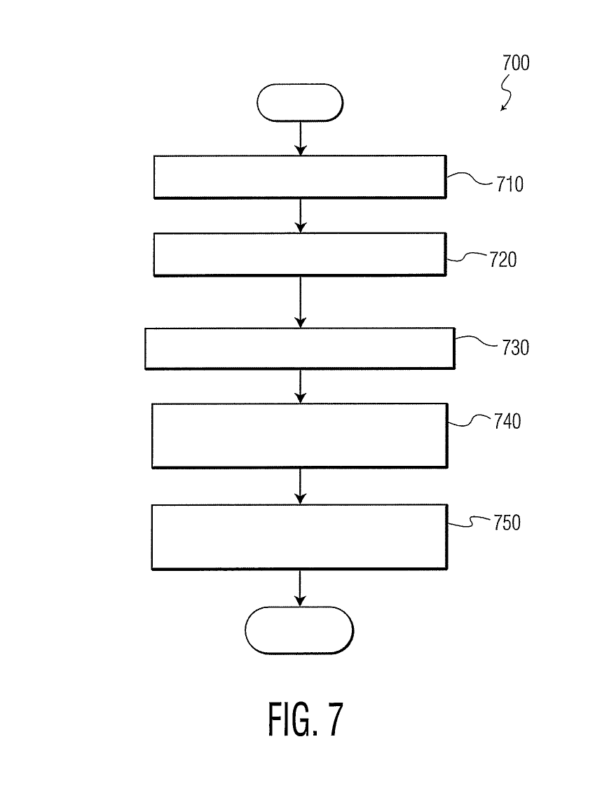

FIG. 7 illustrates a flow chart showing the steps for filtering threads of a chat room in accordance with an advantageous embodiment of the present invention.

FIGS. 1-7, discussed below, and the various embodiments used to describe the principles of the present invention in this patent document are by way of illustration only and should not be construed in any way to limit the scope of the present invention. The present invention may be used in any suitable chat room environment.

FIG. 1 is a schematic overview of an exemplary system 100 for managing threads in a chat room in accordance with the principles of the present invention. System 100 includes a distributed computing network 50. In one embodiment, network 50 is the Internet or World Wide Web (“Web”). In other embodiments, network 50 can be a private network or other network capable of transmitting data.

Connected to network 50 are chat server 150 and a plurality of chat terminals 10 associated with chat clients. Each chat terminal 10 comprises a monitor 20 or other type of display device for displaying chat lines to the chat client and one or more input devices 30 and 40 for receiving input (e.g., chat lines) from the chat client. For example, each chat terminal 10 can include a keyboard 30 and mouse 40 to enter chat lines into chat terminal 10 for transmission to chat server 150 via network 50. Other input devices (not shown) may include microphone, joystick, game pad, satellite dish, scanner or the like. In addition, chat terminal 10 may include other peripheral output devices (not shown), such as speakers and printers.

Chat server 150 includes input/output (I/O) unit 110 for transmitting and receiving chat lines to and from chat terminals 10 via network 50. Chat server 150 further includes chat controller 120 for facilitating communication (e.g., chat lines) between chat terminals 10 via network 50 in real time. Chat controller 120 manages one or more chat rooms, each having one or more chat terminals 10 registered therewith. Chat controller 120 receives chat lines from registered chat terminals 10 associated with a particular chat room and retransmits received chat lines to each chat terminal 10 registered with the particular chat room.

In accordance with embodiments of the present invention, chat server 150 also includes thread management controller 130. Thread management controller 130 is operable to manage conversation threads in one or more chat rooms controlled by chat controller 120. Thread management controller 130 determines one or more associations between the chat lines in a particular chat room using one or more thread management techniques, which will be described in more detail below, and identifies one or more threads corresponding to the associations. As used herein, the term “thread” refers to a set of chat lines in a particular time interval that are related to each other by one or more associations. A particular chat line can be related to zero (new thread) or more previous chat lines. In one embodiment, thread management controller 130 further assigns each of the chat lines to one of the threads, determines the chat clients (chat terminals 10) associated with the chat lines in each of the threads and provides to each of the chat clients only those chat lines assigned to the associated thread. As a result, thread management controller 130 is operable to filter off-topic threads and create new chat rooms via chat controller 120 for off-topic threads and their chat clients. In another embodiment, thread management controller 130 is operable to visually delineate threads when displayed. For example, thread management controller 130 can set up the screen layout such that the chat lines relating to each thread are linked using tabs, lines, or any other linking mechanism.

In a further embodiment, thread management controller 130 provides chat line references usable by the chat clients to refer to the chat lines. Thus, thread management controller 130 is further operable to provide a mechanism for chat clients to follow the chat room conversation. For example, once threads in a chat room are identified, thread management controller 130 can enable naming of the threads to help chat clients identify the chat lines that are of interest to them. In one embodiment, the chat clients themselves can assign a new, static name to an automatically detected thread. In another embodiment, using thesaurus-lookups or other mechanism, thread management controller 130 can relate keywords in a thread and choose one or more defining keywords as the thread name. By basing the thread name on the last “X” chat lines, the name of a thread can automatically change as the topic in the thread changes. In a further embodiment, thread management controller 130 can be operable to enable a chat client to create a new chat room, using one of the thread names as input, and thread management controller 130 can automatically invite chat clients belonging to the thread to the new chat room.

Various thread management techniques can be used by thread management 30 controller 130 to structure conversations in chat rooms. For example, in one embodiment, thread management controller 130 can determine the probability that a particular chat line relates to a previous chat line. If a chat line is sent within a predefined time interval [a,b], the probability is high that the chat line refers to an immediately preceding chat line, and therefore in the same thread. Outside of the predefined time interval [a,b], the probability is low. The predefined time interval [a,b] can be determined by the typical chat client reaction speed, taking into consideration both the time that a chat client begins to type a response and the time the chat client sends the response.

In another embodiment, thread management controller 130 can use a keyword match technique to structure chat room conversations. For example, if a chat line is sent that contains keywords of a previous chat line, there is a high probability that the chat line is a reaction to the previous chat line or at least in the same thread. In a further embodiment, thread management controller can use a frequent interaction technique to identify threads in a chat room. If two chat clients interact frequently, there is a high probability that two nearby chat lines of these two chat clients are related, and thus in the same thread. For example, if two chat clients have each other in their on-line “buddy list,” there is a high probability that chat lines of these two chat clients are related, and thus in the same thread.

In still a further embodiment, thread management controller 130 can use a same client technique to determine the associations between chat lines in a chat room. With a certain probability, the chat lines transmitted by a particular chat client relate to each other. The probability increases when an earlier chat line is unfinished (broken sentence), contains a spelling error, is very long or indicates a list. In an additional embodiment, thread management controller 130 can use a grammar analysis technique to determine threads in a chat room. For example, thread management controller 130 can identify question-answer pairs between chat lines. In a further additional embodiment, thread management controller 130 can use a “popular” chat client filter technique to determine which thread(s) a particular chat line belongs to. For example, thread management controller 130 can track “popular” chat clients that elicit numerous non-negative reactions and can splice the chat lines of a “popular” chat client into one or more threads or one or more chat rooms to keep the chat conversation lively. Any reactions to the spliced-in chat lines can be made visible to the “popular” chat client, regardless of which thread or chat room the “popular” chat client is assigned to.

In still a further additional embodiment, thread management controller 130 can use a filter technique to determine which thread a particular chat line belongs to. For example, if a thread is filtered from a particular chat client, such that the particular chat client does not see the chat lines of the thread, there is a high probability that a chat line transmitted by the particular chat client is not associated with that thread. In still a further additional embodiment, thread management controller 130 can use an identification technique to determine the association between chat lines. Chat clients can explicitly refer to a previous chat line in their chat line. For example, a chat client can click using mouse 40 on a previous chat line before sending their chat line, or a chat client can refer to a previous chat line by a chat line identifier. As an example, a single letter can be provided next to each chat line, and the letters can be reused as chat lines scroll up. As another example, thread names can be assigned by chat clients or thread management controller 130, as described above. It should be understood that the thread management techniques described herein are merely illustrative of the many types of techniques that can be used. Thus, the present invention is not limited to the thread management techniques mentioned above.

FIG. 2 is a block diagram of an exemplary computer 10 comprising thread management capabilities in accordance with the principles of the present invention. Computer 10 corresponds to chat terminal in FIG. 1. Computer 10 includes a processor 15, memory 16 and I/O Unit 12. I/O Unit 12 transmits and receives chat lines to and from network 50 (shown in FIG. 1). Processor 15 can be any microprocessor, microcontroller or programmable processing device. Memory 16 can be any type of computer readable media, including but not limited to random access memory (RAM), read only memory (ROM), flash memory, EEPROM, disk drive (e.g., hard disk drive, magnetic disk drive or optical disk drive), floppy disk, tape drive, CDROM, DVD or any other type of storage device.

Memory 16 provides non-volatile storage of computer readable instructions, data structures and other data for computer 10. For example, memory 16 can store web browser 18, chat controller 14 and thread management controller 19. Web browser 18 is 30 run by processor 15 to access network 50. Chat controller 14 is run by processor 15 and manages connectivity and message delivery between computer 10 and chat server 150 (shown in FIG. 1). Chat controller 14 provides functionality similar to chat controller 120 (shown in FIG. 1). However, chat controller 14 is applicable to a single computer 10 registered with one or more specific chat rooms provided by chat server 150. Chat controller 14 can communicate with chat controller 120 on chat server 150. Thread management controller 19 is run by processor 15 and manages conversation threads in one or more chat rooms that computer 10 is registered with. Thread management controller 19 provides functionality similar to thread management controller 130 (shown in FIG. 1). However, thread management controller 19 is applicable to a single computer 10 registered with one or more specific chat rooms provided by chat server 150.

For example, thread management controller 19 can be operable to receive all chat lines for a particular chat room from chat server 150 and determine one or more associations between the chat lines in that particular chat room using one or more thread management techniques, described above. Thread management controller 19 can be further operable to identify one or more threads corresponding to the associations and determine which threads the chat client associated with computer 10 is interested in, using one or more thread management techniques described above or manual thread selection by the chat client. For example, in one embodiment thread management controller 19 can assign identifiers to each of the threads and allow the chat client to select one or more threads that are of interest to the chat client. In another embodiment, thread management controller 19 can filter threads not associated with the chat client and display only those chat lines associated with the unfiltered threads. Thread management controller 19 can be further operable to enable naming of the threads, either manually or automatically, to help the chat client identify the chat lines that are of interest, as described above. In other embodiments, thread management controller 19 can communicate with thread management controller 130 on chat server 150 to perform chat line filtering. For example, thread management controller 130 on chat server 150 can filter certain chat lines (e.g., offensive chat lines), and thread management controller 19 on computer 10 can filter other chat lines (e.g., uninteresting topics for the chat client).

FIG. 3 is block diagram of an exemplary interactive television system 300 comprising thread management capabilities in accordance with the principles of the present invention. Interactive television system 300 includes broadcast server 320, such as a digital video broadcasting network server, that broadcasts a broadcast signal 315 to communication devices 305 (only one of which is shown, for simplicity). Broadcast signal 315 can include, for example, interactive television signals comprised of an audio/video portion of a television program 322 and an interactive portion including chat lines associated with a chat room pertaining to the television program.

Broadcast server 320 includes transceiver 324 for transmitting broadcast signal 315 to communication device 305. Broadcast server 320 further includes chat controller 326 for facilitating communication (e.g., chat lines) between communication devices 305 in real time. Chat controller 326 manages one or more chat rooms associated with television program 322, each having one or more communications devices 305 registered therewith. Chat controller 326 receives chat lines from registered communications devices 305 associated with a particular chat room and retransmits received chat lines to each communications device 305 registered with the particular chat room over broadcast signal 315. Chat controller 326 provides functionality similar to chat controller 120 (shown in FIG. 1). However, chat controller 326 provides chat lines to transceiver 324 for broadcast with television program 322 over broadcast signal 315.

Broadcast server 320 also includes thread management controller 328. Thread management controller 328 is operable to manage conversation threads in one or more chat rooms controlled by chat controller 326. Thread management controller 328 determines one or more associations between the chat lines in a particular chat room using one or more thread management techniques, as described above, and identifies one or more threads corresponding to the associations. Thread management controller 328 provides functionality similar to thread management controller 130 (shown in FIG. 1). It should be understood that in other embodiments, thread management controller 328 can be implemented within receiver 330, and function similar to thread management controller 19 described above in connection with FIG. 2.

Communication device 305 typically includes a receiver 330, such as a set-top box, connected to an antenna 340, a display 310, such as a monitor or television set, and a back channel interface 350 to broadcast server 320 via network 50. Receiver 330 may be integrated into display 310 or be a stand-alone device, such as a set-top box. Receiver 330 comprises transceiver 332, processor 334 and memory 337. Transceiver 332 is operable to transmit chat lines to broadcast server 320 over back channel interface 350 and receive broadcast signal 315 from broadcast server 320 via antenna 340. Processor 334 can be any microprocessor, microcontroller or programmable processing device. Memory 336 can be any type of computer readable media, including but not limited to random access memory (RAM), read only memory (ROM), flash memory, EEPROM, disk drive (e.g., hard disk drive, magnetic disk drive or optical disk drive), floppy disk, tape drive, CDROM, DVD or any other type of storage device.

Memory 336 provides non-volatile storage of computer readable instructions, data structures and other data for computer 10. For example, memory 336 can store web browser 337 and chat controller 338. Processor 334 runs chat controller 338 to separate the interactive portion of the signal from the A/V portion of the signal. Processor 334 runs web browser 337 to establish back channel interface 350 to broadcast server 320 via network 50 to register with a chat room. Processor 334 further runs chat controller 338 and web browser 337 to construct a display signal that integrates the A/V portion and the interactive portion of the broadcast signal in a suitable format, as requested by the chat client, and to provide the display signal to display 310 for display thereon.

FIG. 4 is a logical flow diagram illustrating chat line filtering in accordance with an advantageous embodiment of the present invention. FIG. 4 illustrates a typical chat room environment where communication is sent within a chat room between chat clients 410 and 420 through a server 400 that manages the chat room. Server 400 corresponds to chat server 150 of FIG. 1, broadcast server 320 or any other server capable of managing chat rooms. Chat clients 410 and 420 correspond to chat terminals 10 of FIG. 1, communication devices 305 of FIG. 3 or any other user device capable of registering with a chat room and sending and receiving chat lines in the chat room.

In FIG. 4, each chat client 410 and 420 is shown receives chat lines for a single chat room from server 400. Chat client #1 410 is shown connected to server 400 to receive chat lines 412 associated with a particular conversation thread (e.g., Thread #1) in the chat room. Chat client #1 410 is further shown connected to server 400 to transmit chat lines 414 related to Thread #1. Thus, for chat client #1 410, server 400 includes thread management controller to associate chat lines with threads and filter chat lines individually to each chat client to include only those related to the thread(s) associated with each chat client.

Chat client #2 420 is shown connected to server 400 to receive chat lines 422 associated with multiple conversation threads (e.g., Thread #1 and Thread #2) in the chat room. Chat client #2 420 is further shown connected to server 400 to transmit chat lines 424 related to the chat room. In one embodiment, for chat client #2 420, server 400 includes thread management controller to associate chat lines with threads and filter chat lines to include only those related to Threads #1 and #2. In another embodiment, for chat client #2 420, server 400 includes thread management controller to manually or automatically name conversation threads (e.g., Thread #1 and Thread #2) in the chat room and provide an associated thread name for each chat line sent to chat client #2 420. In a further embodiment, chat client #2 implements thread management controller to selectively filter or identify chat lines for display to chat client #2.

FIG. 5 is a schematic view of a display device 500 for displaying threads 520a, 520b and 520c of a chat room 505 in accordance with another advantageous embodiment of the present invention. Display device 500 corresponds to monitor 20 in FIG. 1, display 310 in FIG. 3 or any other device capable of displaying chat room 505. Chat room 505 displayed on display device 500 includes chat window 510 in which chat lines provided by chat clients registered with chat room 505 are displayed. Chat room 505 further includes buttons identifying conversation threads 520a, 520b and 520c (three of which are shown for illustration) in the chat room. Threads 520a, 520b and 520c can include thread names to identify the current threads in chat room 505 and enable the chat client to easily determine which thread a particular chat line relates to (e.g., by including thread names next to each chat line in chat window 510). Threads 520a, 520b and 520c can further be selectable for display by the chat client using an input device (e.g., mouse 40 shown in FIG. 1). For example, if the chat client is only interested in Thread #1 520a, the chat client can select the button “Thread #1” 520a, and only those chat lines related to Thread #1 520a will appear in chat window 510. The chat client can also select multiple threads 520a, 520b and 520c to appear in chat window 510 and can change the thread(s) 520a, 520b and 520c appearing in chat window 510. Although not shown, it should be understood that in other embodiments, display device 500 could display multiple chat rooms, along with the names of the current threads within each chat room, for the chat client to select from.

FIG. 6 illustrates a flow chart showing the steps for managing threads of a chat room in accordance with the principles of the present invention. The steps shown in FIG. 6 are collectively referred to with reference numeral 600. At step 610, a plurality of chat lines are received from registered chat terminals associated with a particular chat room at the chat server or the chat terminal. At step 620, one or more associations between the chat lines in a particular chat room are determined using one or more thread management techniques, as described above. From the determined associations, one or more threads are identified at step 630 and each of the chat lines is assigned to one of the threads at step 640. At step 650, one or more new chat lines are received and a determination is made whether the new chat line(s) belong to an existing thread at step 660. If so, the new chat line(s) are assigned to the existing thread at step 670. If not, a new thread is created for the new chat line(s) and the new chat line(s) are assigned to the new thread at step 680.

FIG. 7 illustrates a flow chart showing the steps for filtering threads of a chat room in accordance with an advantageous embodiment of the present invention. The steps shown in FIG. 7 are collectively referred to with reference numeral 700. At step 710, a plurality of chat lines are received from registered chat terminals associated with a particular chat room at the chat server or the chat terminal. At step 720, each of the chat lines is assigned to a particular conversation thread. At step 730, the chat clients are associated with the threads based on the chat line assignments performed in step 720. At step 740, for each chat client, the threads not associated with the chat client are filtered, and the chat lines associated with the non-filtered threads are provided to each of the chat clients.

While the present invention has been described in detail with respect to certain embodiments thereof, those skilled in the art should understand that they can make various changes, substitutions, modifications, alterations and adaptations in the present invention without departing from the concept and scope of the invention in its broadest form.

1. A system for providing thread management in a network chat environment, comprising:
a chat controller (120) operable to provide an exchange of information in the form of a plurality of chat lines between a plurality of chat clients registered with a chat room (505); and
a thread management controller (130) operable to determine one or more associations between the plurality of chat lines, identify one or more threads (520) corresponding to the one or more associations and assign each of the plurality of chat lines to one of the one or more threads (520).

2. The system of claim 1, further comprising:
a chat server (150) connected via a distributed computing network (50) to the plurality of chat clients, said chat controller (120) and said thread management controller 130 being implemented on said chat server (150).

3. The system of claim 1, further comprising:
a computer (10) associated with one of the plurality of chat clients, said chat controller (14) and said thread management controller (19) being implemented on said computer (10).

4. The system of claim 1, wherein said network chat environment comprises an interactive television system (300), said chat room (505) being related to a television program (322), and further comprising:
a broadcast server (320) operable to broadcast said television program (322), said chat controller (326) and said thread management controller (328) being implemented on said broadcast server (320); and
a receiver (330) associated with one of the plurality of chat clients, said receiver (330) being operable to receive said television program (322) and said plurality of chat lines, said receiver (330) being further operable to display said television program (322) and said plurality of chat lines on a display device (310).

5. The system of claim 1, further comprising:
a display (20) associated with a select one of said plurality of chat clients, each of said threads (520) being displayed on said display (20); and
a user interface associated with said select chat client, said user interface being operable to receive input from said select chat client, said input selecting one of said threads (520) for display on said display (20).

6. The system of claim 1, wherein said thread management controller (130) is further operable to associate each of said plurality of chat clients with one of said threads (520) and provide to each of said chat clients ones of said chat lines assigned to said associated thread (520).

7. The system of claim 1, wherein said thread management controller (130) is operable to determine said one or more associations between said plurality of chat lines based on a probability of relating between consecutive ones of said plurality of chat lines.

8. The system of claim 7, wherein the probability of relating is measured by a time interval in which a new one of the plurality of chat lines is sent with respect to a previous one of the plurality of chat lines.

9. The system of claim 1, wherein said thread management controller (130) is operable to determine said one or more associations between said plurality of chat lines based on a keyword match between said plurality of chat lines.

10. The system of claim 1, wherein said thread management controller (130) is operable to determine said one or more associations between said plurality of chat lines based on a user interaction between two of said plurality of chat clients.

11. The system of claim 1, wherein said thread management controller (130) is operable to determine said one or more associations between said plurality of chat lines based on commonality of authorship between said plurality of chat lines.

12. The system of claim 1, wherein said thread management controller (130) is operable to determine said one or more associations between said plurality of chat lines based on a grammar analysis of said plurality of chat lines.

13. The system of claim 1, wherein said thread management controller (130) is further operable to provide a respective name for each of said one or more threads (520).

14. The system of claim 13, wherein each said respective name is assigned by at least one of the plurality of chat clients.

15. The system of claim 13, wherein each said respective name is assigned by said thread management controller (130) using keywords in said plurality of chat lines.

16. The system of claim 13, wherein said thread management controller (130) is further operable to receive as input a select one of said respective names from one of said chat clients to create a new chat room (505), said thread management controller (130) being further operable to automatically invite said chat clients associated with said thread (520) having said select name to said new chat room (505).

17. The system of claim 1, wherein said thread management controller (130) is further operable to provide chat line references usable by said plurality of chat clients to refer to each of said plurality of chat lines.

18. A method for managing threads (520) in a network chat environment, comprising:
receiving a plurality of chat lines from a plurality of chat clients registered with a chat room (505);
determining one or more associations between the plurality of chat lines;
identifying one or more threads (520) corresponding to the one or more associations; and
assigning each of the plurality of chat lines to one of the one or more threads (520).

19. The method of claim 18, further comprising:
receiving input from a select one of said plurality of chat clients, said input selecting one of said threads (520); and
displaying at least said selected thread (520) to said select chat client.

20. The method of claim 18, further comprising:
associating each of said plurality of chat clients with one of said threads (520); and
providing to each of said chat clients ones of said chat lines assigned to said associated thread (520).

21. The method of claim 18, wherein said determining comprises determining a probability of relating between consecutive ones of said plurality of chat lines.

22. The method of claim 21, wherein said determining the probability of relating further comprises measuring a time interval in which a new one of the plurality of chat lines is sent with respect to a previous one of the plurality of chat lines.

23. The method of claim 18, wherein said determining further comprises performing a keyword match between said plurality of chat lines.

24. The method of claim 18, wherein said determining further comprises analyzing a user interaction between two of said plurality of chat clients.

25. The method of claim 18, wherein said determining further comprises determining a commonality of authorship between said plurality of chat lines.

26. The method of claim 18, wherein said determining further comprises performing a grammar analysis of said plurality of chat lines.

27. The method of claim 18, further comprising:
providing a respective name for each of said one or more threads (520).

28. The method of claim 27, wherein said providing further comprises assigning each said respective name by at least one of the plurality of chat clients.

29. The method of claim 27, wherein said providing further comprises assigning each said respective name using keywords in said plurality of chat lines.

30. The method of claim 18, further comprising:
providing chat line references usable by said plurality of chat clients to refer to each of said plurality of chat lines.

31. A computer readable medium containing computer executable instructions to perform a method for managing threads (520) in a network chat environment, the method comprising:
receiving a plurality of chat lines from a plurality of chat clients registered with a chat room (505);
determining one or more associations between the plurality of chat lines;
identifying one or more threads (520) corresponding to the one or more associations; and
assigning each of the plurality of chat lines to one of the one or more threads (520).

32. A computer programmed to execute a process for managing threads (520) in a network chat environment, the process comprising:
receiving a plurality of chat lines from a plurality of chat clients registered with a chat room (505);
determining one or more associations between the plurality of chat lines;
identifying one or more threads (520) corresponding to the one or more associations; and
assigning each of the plurality of chat lines to one of the one or more threads.
